(19) United States
(12) Patent Application Publication
(10) Pub. No.: US 2005/0262175 A1
(43) Pub. Date: Nov. 24, 2005

(54) Trigonometric wave generation circuit using series expansion

(76) Inventors: Yukinobu Iino, Kyoto (JP); Naoki Kurihara, Kyoto (JP)

Correspondence Address: CANTOR COLBURN, LLP, 55 GRIFFIN ROAD SOUTH, BLOOMFIELD, CT, 06002, US

(21) Appl. No.: 11/132,066

(22) Filed: May 18, 2005

(30) Foreign Application Priority Data
May 18, 2004 (JP) JP2004-147270
May 12, 2005 (JP) JP2005-139315

(51) Int. Cl. G06F 1/02

(52) U.S. Cl. 708/276

(57) ABSTRACT

A DTMF signal generating circuit is provided with a frequency designating unit which designates frequencies to form a DTMF signal, a sinusoidal wave computing unit which computes sinusoidal waves by referring to frequencies designated by the frequency designating unit, and a sinusoidal wave synthesizing unit which synthesizes two sinusoidal waves computed by the sinusoidal wave computing unit. The sinusoidal wave computing unit is provided with operators such as an adder-subtracter and a multiplier and generates a sinusoidal wave by determining terms of a Taylor expansion of a sinusoidal function by arithmetic operation.

### BACKGROUND OF THE INVENTION

1. Field of the Invention

The present invention relates to a circuit for generating a trigonometric wave such as a sinusoidal wave and, more particularly, to a circuit applicable to a circuit for generating a DTMF signal using a sinusoidal wave.

2. Description of the Related Art

Signals such as sinusoidal waves represented by trigonometric functions are used in a variety of fields. For example, a Dual Tone Multi-Frequency (DTMF) signal used as a dial signal in a touch-tone system is generated by combining sinusoidal waves at two frequencies. The technology for generating a trigonometric wave such as a sinusoidal wave by converting a digital signal into an analog signal is known in the related art. For example, patent document No. 1 discloses a circuit that reads sinusoidal waveform data from a sinusoidal wave data table so as to generate a digital DTMF signal and convert the DTMF signal into an analog signal by a D/A converter.

When the DTMF signal generated based on the data table is combined for use with another signal such as an audio signal, the DTMF signal and the another signal may be combined by a circuit as illustrated in FIG. 5. The circuit illustrated in FIG. 5 comprises a DTMF signal synthesizing block 60 and an audio signal codec block 62. The DTMF signal synthesizing block 60 is provided with an address computing unit 64 that computes an address on a sinusoidal wave data table in accordance with a frequency supplied, a sinusoidal data table storage unit 66 that holds a data table related to sinusoidal waves, and a digital-to-analog converting unit 68 (hereinafter, also referred to as DAC 68). The audio signal codec block 62 is provided with an interpolator unit 70, a ΔΣ DAC 72, and a smoothing filter 74 (hereinafter, also referred to as an SMF unit 74) that functions as a post filter. The DTMF signal generated by the DTMF signal synthesizing block 60 and the audio signal generated by the audio signal codec block 62 are synthesized as analog signals in a mixing unit 76. The resultant analog signal is output as a sound signal.

[Patent Document No. 1]

JP 8-163224 A

In a circuit that generates a trigonometric wave using a data table, a storage such as ROM for storing a data table is necessary. In order to generate accurate trigonometric waves, a data table that includes detailed information needs to be used in such a circuit. Further, for improvement in time resolution, it is necessary to store data with small time intervals in the data table. For this reason, in the circuit that utilizes a data table, the storage capacity for storing the data table needs to be enlarged in order to generate accurate trigonometric waves, causing the circuit scale to be enlarged.

Also, when the DTMF signal and another signal such as an audio signal are synthesized as analog signals as in the circuit illustrated in FIG. 5, not only a DAC for converting the DTMF signal into an analog signal but also a DAC for converting the another signal such as an audio signal into an analog signal are necessary. This is one of the factors that cause the circuit area to be enlarged.

In an arrangement where a trigonometric wave is generated using software instead of a data table, a trigonometric wave is usually generated using a general-purpose processor such as a Digital Signal Processor (DSP). Therefore, the circuit scale tends to be enlarged and power consumption tends to be increased.

### SUMMARY OF THE INVENTION

The present invention has been done in view of the aforementioned circumstances and its object is to provide a technology designed to reduce the scale of circuit for generating a trigonometric wave.

The present invention according to one aspect provides a trigonometric wave generating circuit. The trigonometric wave generating circuit according to this aspect comprises an operator which determines terms of a series expansion of a trigonometric function by direct arithmetic operation, so as to generate a trigonometric wave. Since the trigonometric wave generating circuit directly generates a trigonometric wave by arithmetic operation based on series expansion, the need for storage for storing relatively large data related to sinusoidal waves is eliminated. The series expansion may be an expansion into a series of powers. For example, Taylor expansion and Maclaulin expansion are encompassed.

The operator may further comprise a memory which retains coefficients of the terms of the series expansion of the trigonometric function. The operator may perform the operation after bounding the phase value of the trigonometric function to a range from −½π to ½π by a shift operation. By bounding the phase value that varies from −π to π to a range from −π/2 to π/2, it is ensured that the absolute value of the independent variable of the trigonometric function is small so that an error of the dependent variable of the generated trigonometric function is reduced.

The present invention according to another embodiment provides a DTMF signal generating circuit. The DTMF signal generating circuit according to this aspect comprises: a first frequency sinusoidal wave generating unit which computes a sinusoidal wave of a first frequency using a series expansion; a second frequency sinusoidal wave generating unit which computes a sinusoidal wave of a second frequency using a series expansion; and a sinusoidal wave synthesizing unit which synthesizes the sinusoidal wave computed by the first frequency sinusoidal wave generating unit and the sinusoidal wave computed by the second frequency sinusoidal wave generating unit. Since the DTMF signal generating circuit according to this aspect generates a DTMF signal by synthesizing sinusoidal waves computed by using series expansion, the need for storage for storing relatively large data related to sinusoidal waves is eliminated. The sinusoidal wave referred to here is inclusive of not only sine waves but also trigonometric waves such as cosine waves differing only in phases are included.

The first frequency sinusoidal wave generating unit and the second frequency sinusoidal wave generating unit may be formed to share a single trigonometric wave generating circuit. The DTMF signal generating circuit may further comprise a frequency designating unit which designates the first frequency and the second frequency to the single trigonometric wave generating circuit. Since the single trigonometric wave generating circuit is capable of computing trigonometric waves at the first frequency and the second frequency, the circuit area is reduced.

The present invention according to still another embodiment provides a sound signal generating circuit. The sound signal generating circuit according to this aspect comprises: the DTMF signal generating circuit described above; an acoustic signal generating unit which generates a digital acoustic signal; and a mixing unit which mixes the digital DTMF signal generated by the DTMF signal generating unit with the digital acoustic signal generated by the acoustic signal generating unit. Since the sound signal generating circuit uses the DTMF signal generated from the sine waves computed by using series expansion, the need for storage for storing relatively large data related to sine waves is eliminated. Since the DTMF signal and the acoustic signal are mixed in a digital stage, it is not necessary to provide DACs for digital-to-analog conversion for each of the DTMF signal and the acoustic signal. The acoustic signal referred to here is inclusive of not only speech uttered by a person but also a sound-related signal in general.

The sound signal generating circuit may further comprise: an interpolator which interpolates between values of the sound signal mixed by the mixing unit; a ΔΣ D/A converter which subjects an output signal from the interpolator to digital-to-analog conversion; and a filter provided in a stage subsequent to the ΔΣ D/A converter. By performing ΔΣ modulation and oversampling, noise shaping is effected and high-quality sound is obtained.

The present invention according to yet another aspect provides a communication apparatus. The communication apparatus comprises the audio signal generating circuit described above. Since the scale of a block for generating a sinusoidal wave is reduced according to this communication apparatus, the overall size of apparatus is reduced.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 is a block diagram illustrating the overall structure of an audio signal generating circuit.

FIG. 2 is a block diagram illustrating the overall structure of a DTMF signal generating circuit.

FIG. 3 illustrates the circuit architecture of a sinusoidal wave computing unit.

FIG. 4 is a flow chart illustrating steps for computing a sinusoidal wave in the sinusoidal wave computing unit.

FIG. 5 is a block diagram illustrating an example of related-art circuit that combines a DTMF signal and an audio signal so as to output a desired sound signal.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

According to an embodiment of the present invention that will be described below, a sinusoidal wave is computed promptly and with precision, by determining each of the terms of a Taylor expansion of a sinusoidal function by direct arithmetic operation that uses hardware.

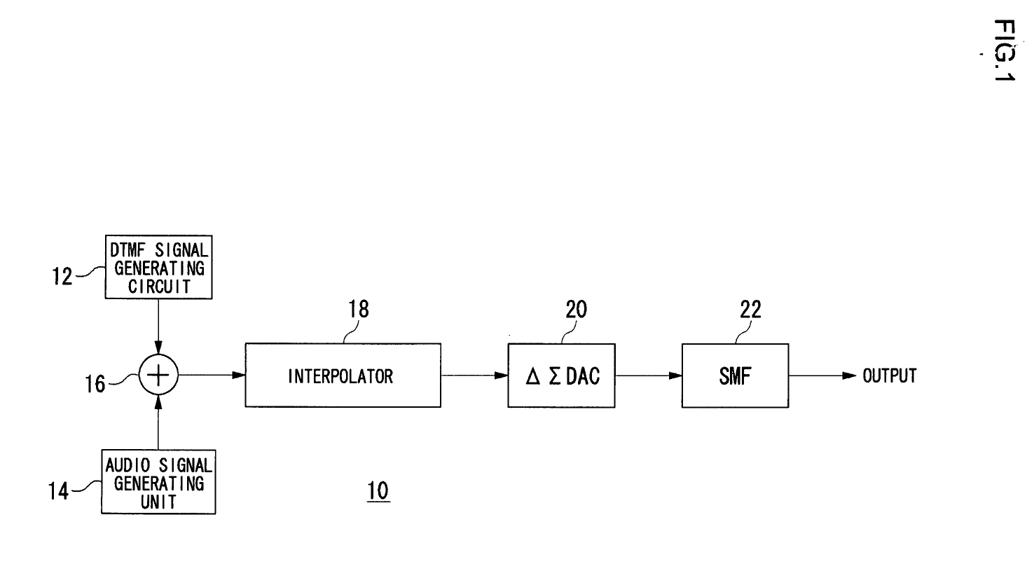

FIG. 1 is a block diagram illustrating the overall structure of a sound signal generating circuit 10. The sound signal generating circuit 10 is provided with a DTMF signal generating circuit 12 that generates a digital DTMF signal, an audio signal generating unit 14 that generates a digital audio signal related to audio, and a mixing unit 16 that generates a digital audio/DTMF signal by mixing the DTMF signal and the audio signal. The sound signal generating circuit 10 is further provided with an interpolator 18, a ΔΣ digital-to-analog converter 20 (hereinafter, referred to as a ΔΣ DAC 20) that convert the digital audio/DTMF signal into an analog signal and a smoothing filter 22 (hereinafter, referred to as an SMF 22).

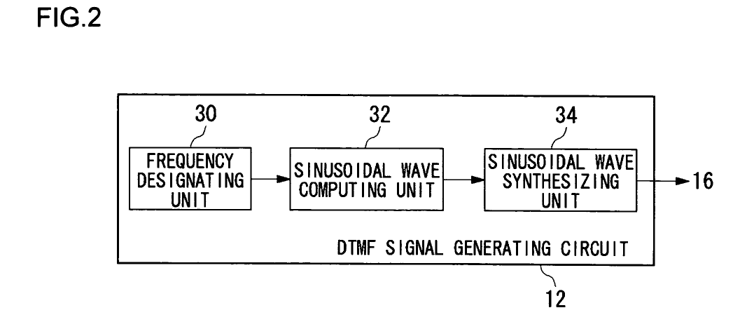

The DTMF signal generating circuit 12 has the structure described later and illustrated in FIG. 2 and generates a digital DTMF signal using a sinusoidal wave computed by using a Taylor expansion.

The audio signal generating unit 14 generates an audio signal digitized by the Pulse Code Modulation (PCM) scheme. For example, the audio signal generating unit 14 is used in communication equipment such as a telephone and processes audio input to the phone into PCM data so as to generate a digital audio signal. The sampling frequency in the audio signal generating unit 14 is fixed.

The mixing unit 16 mixes the digital DTMF signal sent from the DTMF signal generating circuit 12 and the digital audio signal sent from the audio signal generating unit 14 by a known method, so as to generate a digital audio/DTMF signal.

The interpolator 18 applies an interpolation process that interpolates between the digital audio/DTMF signal values generated in the mixing unit 16. Interpolation by the interpolator 18 is conducted by oversampling between original sample values. This increases the apparent sampling frequency of the audio/DTMF signal, facilitating the audio/DTMF signal to be converted into an analog signal with high precision by the ΔΣ DAC 20 and the SMF 22.

The ΔΣDAC 20 converts the digital audio/DTMF signal sent from the interpolator 18 into an analog signal by the ΔΣ modulation scheme. The ΔΣ modulation scheme utilizes the noise shaping technology. By using it in combination with the interpolation process in the interpolator 18, the audio/DTMF signal can be converted into an analog signal with even higher precision.

The SMF 22 is a kind of analog low-pass filter that serves as a post-filter. The SMF 22 shapes the audio/DTMF signal into an analog signal of a natural form, by removing components which are contained in the output waveform of the audio/DTMF signal obtained by digital-to-analog conversion in the ΔΣ DAC 20 and which are folded back from a range above the sampling frequency.

FIG. 2 is a block diagram illustrating the structure of the DTMF signal generating circuit 12. The DTMF signal generating circuit 12 is provided with a frequency designation unit 30 that selects desired frequencies in predetermined frequency groups, a sinusoidal wave computing unit 32 that computes a sinusoidal wave using a Taylor expansion, and a sinusoidal wave synthesizing unit 34 that synthesizes the sinusoidal waves computed by the sinusoidal wave computing unit 32.

The frequency designating unit 30 designates frequencies of sinusoidal waves to be computed by the sinusoidal wave computing unit 32. The frequency designating unit 30 according to the embodiment selects the higher of the frequencies forming the DTMF signal from a higher frequency group comprising relatively higher frequencies, and also selects the lower of the frequencies forming the DTMF signal from a lower frequency group comprising relatively lower frequencies. According to this embodiment, the higher frequency group is formed of 1209 Hz, 1336 Hz, 1477 Hz and 1633 Hz, and the lower frequency group is formed of 697 Hz, 770 Hz, 852 Hz and 941 Hz. The frequency designating unit 30 designates the selected frequencies to the sinusoidal wave computing unit 32. Selection of the frequencies in the frequency designating unit 30 may be done in accordance with the press of a button of a touch-tone (trademark) telephone by a user.

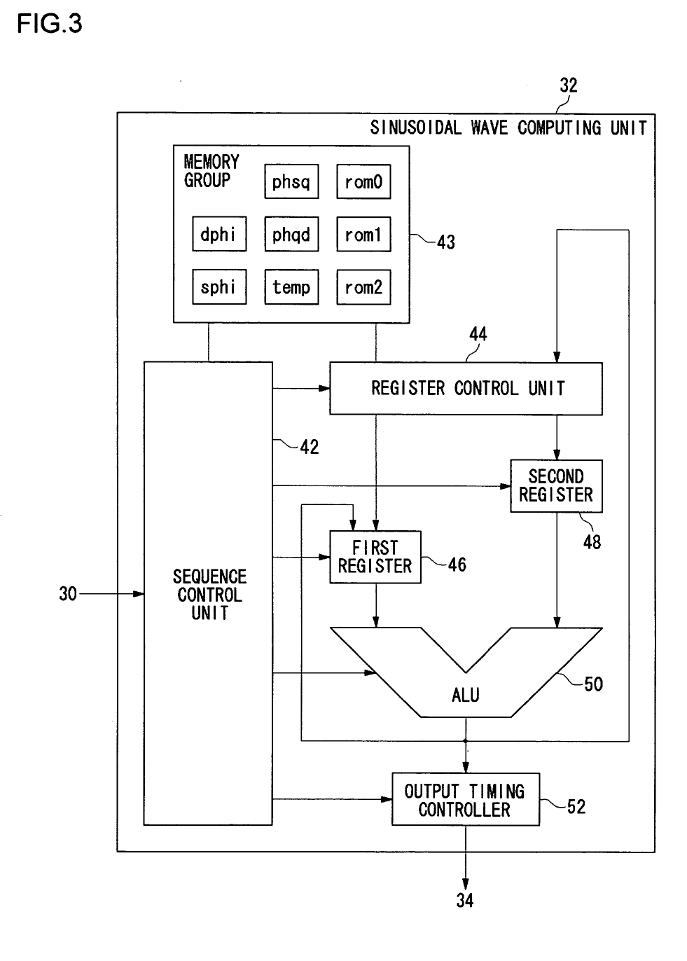

The sinusoidal wave computing unit 32 is provided with the structure illustrated in FIG. 3 and generates a sinusoidal wave using an operator for determining the terms of a Taylor expansion of a sinusoidal function by arithmetic operation, in accordance with the frequency designated by the frequency designating unit 30. In this embodiment, the first frequency sinusoidal wave generating unit and the second frequency sinusoidal wave generating unit are implemented by the sinusoidal wave computing unit 32.

The sinusoidal wave synthesizing unit 34 synthesizes the sinusoidal waves computed by the sinusoidal wave computing unit 32 in a digital stage, one of the sinusoidal waves being at the frequency selected by the frequency designating unit 30 from the higher frequency group (hereinafter, also referred to as a high-range frequency), and the other at the frequency also selected by the frequency designating unit 30 from the lower frequency group (hereinafter, also referred to as a low-range frequency). With this, the desired digital DTMF signal is generated.

FIG. 3 illustrates the circuit architecture of the sinusoidal wave computing unit 32. The sinusoidal wave computing unit 32 includes a sequence control unit 42, a memory group 43, a register control unit 44, a first register 46, a second register 48, an arithmetic and logical unit 50 (hereinafter, denoted as the ALU 50) and an output timing controller 52.

The sequence control unit 42 operates as a sequencer for integrally controlling the parts of the sinusoidal wave computing unit 32. In this embodiment, data related to a sinusoidal wave is obtained by arithmetically computing terms of the Taylor expansion of the sinusoidal function. In relation to this, the sequence control unit 42 controls the parts of the sinusoidal wave computing unit 32 so that the ALU 50 properly computes terms of the Taylor expansion of the sinusoidal function by arithmetic operation. For example, the sequence control unit 42 appropriately supplies operating timings, data and instructions for operation necessary for arithmetic operation to the register control unit 44, the first register 46, the second register 48, the ALU 50 and the output timing controller 52.

The memory group 43 includes dphi, sphi, phsq, phqd and temp in which data can be rewritten easily. The memory group 43 also includes rom0, rom1 and rom2 which are read only memories (ROM). dphi is a memory for holding a phase component in a unit time corresponding to the frequency of the sinusoidal wave generated by the sinusoidal wave computing unit 32. sphi is a memory for holding data related to the phase component of the size wave computed by the sinusoidal wave computing unit 32. phsq is a memory for holding data obtained by squaring the phase component. phqd is a memory for holding data obtained by raising the phase component to the fourth power. temp is a memory for holding various data derived from the operation in the sinusoidal wave computing unit 32. rom0-rom2 are memories for holding coefficients in the operational expression computed by the sinusoidal wave computing unit 32. As described later, the sinusoidal wave is computed in this embodiment by computing the first through third terms of the Taylor expansion of the sinusoidal function (see expression (5) below). For this purpose, rom0 according to this embodiment holds data “1608”, which is a coefficient related to the first term of the Taylor expansion of the sinusoidal function, rom1 holds data “2645”, which is a coefficient related to the second term of the Taylor expansion of the sinusoidal function, and rom2 holds data “1305”, which is a coefficient related to the third term of the Taylor expansion of the sinusoidal function.

The register control unit 44 is controlled by the sequence control unit 42 so as to control data supplied to the memories of the memory group 43, the first register 46 or the second register 48. For example, the register control unit 44 reads data held by the memories of the memory group 43 as required and supplies the same to the first register 46 or the second register 48. The register control unit 44 may also acquire results of operation by the ALU 50 and stores the same in the memories of the memory group 43.

The first register 46 temporarily holds data supplied from the sequence control unit 42, the register control unit 44 or the ALU 50 and supplies the same to the ALU 50 according to a predetermined timing schedule. The second register 48 temporarily holds data supplied from the sequence control unit 42 or the register control unit 44 and supplies the same to the ALU 50 at a predetermined timing schedule. The timing is regulated by the sequence control unit 42.

The ALU 50 includes operators such as a multiplier and an adder-subtracter (not shown). Each of the operators is provided with the function for overflow process or rounding process. The ALU 50 performs arithmetic operation on the data supplied from the first register 46 and the second register 48, in accordance with an arithmetic operation mode designated by the sequence control unit 42. For example, when addition is designated as the arithmetic operation mode by the sequence control unit 42, the ALU 50 adds the data supplied from the first register 46 and the second register 48. The result of operation by the ALU 50 is sent as required to the sequence control unit 42, the first register 46 and the output timing controller 52.

The output timing controller 52 is controlled by the sequence control unit 42 so as to regulate the timing in which the result of operation by the ALU 50 is sent to the sinusoidal wave synthesizing unit 34. In this embodiment, data of the first through third terms, i.e., data up to the fifth-order term in the Taylor expansion of the sinusoidal function, is used to generate a sinusoidal wave, as will be described later. Accordingly, the output timing controller 52 regulates the timing so that the result of operation by the ALU 50 is sent to the sinusoidal wave synthesizing unit 34 at a point of time when computation up to the third term of the Taylor expansion of the sinusoidal function is completed.

A description will now be given of the workings of the sound signal generating circuit 10 according to the embodiment.

The flow performed until a sound signal is output from the sound signal generating circuit 10 will now be described by referring to FIG. 1. In the sound signal generating circuit 10, the digital DTMF signal generated by the DTMF signal generating circuit 12 and the digital audio signal generated by the audio signal generating unit 14 are mixed in the mixing unit 16, so as to generate an audio/DTMF signal. The audio/DTMF signal is sent from the mixing unit 16 to the interpolator 18 for interpolation. The ΔΣ DAC 20 converts the interpolated signal into an analog signal. The SMF 22 shapes it into an analog signal of a natural form. The analog audio/DTMF signal thus obtained is output as a sound signal.

The flow by which the DTMF signal is generated in the DTMF signal generating circuit 12 will be described by referring to FIG. 2. The sinusoidal wave computing unit 32 in the DTMF signal generating circuit 12 computes sinusoidal waves at the high-range frequency and at the low-range frequency selected by the frequency designating unit 30. The sinusoidal wave at the high-range frequency and the sinusoidal wave at the low-frequency range computed by the sinusoidal wave computing unit 32 are synthesized in the sinusoidal wave synthesizing unit 34 so as to generate a digital DTMF signal. The DTMF signal generated by the sinusoidal wave synthesizing unit 34 is sent to the mixing unit 16 where it is mixed with the audio signal.

A description will now be given of the process for computing sinusoidal waves in the sinusoidal wave computing unit 32. The sinusoidal function represented by sin(x) is expressed in a Taylor expansion given by expression (1) below.

$$sinx = x - \frac{{x}^{3}}{3 !} + \frac{{x}^{5}}{5 !} - … + {( - 1 )}^{n - 1} \frac{{x}^{2 n - 1}}{( 2 n - 1 ) !} \qquad ( 1 )$$

Values resulting from computation up to respective terms in expression (1) are related to true values as listed in table 1 below. In connection with expression (1), table 1 lists mutual correspondence between (a) the number of terms up to which computation is performed, (b) the last term computed, (c) the value obtained when x=(π/2), and (d) error in percentage from the true value. x varies in the range of (−π)-+π. The sinusoidal function value in the range of x=(−π)-(−π/2) is the same as the function value in the range of x=(−π/2)−0.

TABLE 1

| | | | |
|---|---|---|---|
| (a) NUMBER OF TERMS UP TO WHICH COMPUTATION IS PERFORMED | (b) LAST TERM COMPUTED | $\begin{matrix}( c ) VALUE OBTAINED \\ WHEN x = \frac{π}{2}\end{matrix}$ | (d) ERROR IN PERCENTAGE FROM THE TRUE VALUE |

| | | | |
|---|---|---|---|
| 1 | x | 1.570796327 | 57.07963268% |
| 2 | $- \frac{{x}^{3}}{3 !}$ | 0.924832229 | −7.51677707% |
| 3 | $+ \frac{{x}^{5}}{5 !}$ | 1.004524856 | 0.45248555% |
| 4 | $- \frac{{x}^{7}}{7 !}$ | 0.999843101 | −0.01568986% |
| 5 | $+ \frac{{x}^{9}}{9 !}$ | 1.000003543 | 0.00035426% |
| 6 | $- \frac{{x}^{11}}{11 !}$ | 0.999999944 | −0.00000563% |
| 7 | $+ \frac{{x}^{13}}{13 !}$ | 0.999999987 | −0.00000132% |

As shown in table 1, an error from the true value is reduced as the number of terms computed is increased. The number of terms of the Taylor expansion of the sinusoidal function to be computed by the sinusoidal wave computing unit 32 is determined depending on the precision of the sinusoidal wave required in the DTMF signal. A noise component Vn (rms) indicating the distance between the value obtained by computing the Taylor expansion of the sinusoidal function and the true value is approximated by expression (2) below.

$$Vn ( rms ) = \sqrt{{\int }_{- \frac{π}{2}}^{\frac{π}{2}} {( x - \frac{{x}^{3}}{3 !} + \frac{{x}^{5}}{5 !} - … + {( - 1 )}^{n - 1} \frac{{x}^{2 n - 1}}{( 2 n - 1 ) !} - sinx )}^{2} ⅆ x} \qquad ( 2 )$$

When the sinusoidal wave computing unit 32 computes up to the third term of the Taylor expansion of the sinusoidal function, the noise component Vthd, obtained by normalizing expression (2) above with respect to signal amplitude, is given by expression (3) below. The signal amplitude in expression (3) is assumed to be 1.

$$Vthd = \frac{Vn}{1} = \sqrt{{\int }_{- \frac{π}{2}}^{+ \frac{π}{2}} {( x - \frac{{x}^{3}}{3 !} + \frac{{x}^{5}}{5 !} - sinx )}^{2} ⅆ x} \qquad ( 3 )$$

It is generally considered that there is no problem with the DTMF signal if the distortion indicating the proportion of the normal signal component with respect to the noise component is 50 dB or greater. Considering the noise component computed according to expression (3), the distortion occurring when the computation is performed up to the third term of the Taylor expansion of the sinusoidal function is approximately 55 dB. In this background, the sinusoidal wave computing unit 32 according to this embodiment obtains the sinusoidal wave by approximation by computing up to the third term of the Taylor expansion of the sinusoidal function.

The relation between the first through third terms of the Taylor expansion of the sinusoidal function is represented by expression (4) below. In expression (4), a phase component φ is used for x, where x=πφ. Since x varies in the range of −πn-+π, the phase component varies in the range of −1-+1.

$$\begin{matrix}sinx ≅ x - \frac{{x}^{3}}{3 !} + \frac{{x}^{5}}{5 !} = π ϕ - \frac{{( πϕ )}^{3}}{6} + \frac{{( πϕ )}^{5}}{120} \\ = 8 ϕ ( 0.392699 - 0.645964 {ϕ}^{3} + 0.318771 {ϕ}^{4} )\end{matrix} \qquad ( 4 )$$

As described below, a data word length of 13 bits is used in this embodiment. By representing expression (4) by two's components of 13 bits and selecting coefficients so that a computation error is minimum, expression (5) is obtained. In order to prevent errors such as overflow from occurring in the process of computing, the value corresponding to 0.9995 sin (πφ) is obtained in expression (5).
sin (πφ)≅0.9995 sin (πφ)≅8φ(1608−2645φ²+1305φ⁴) (5)

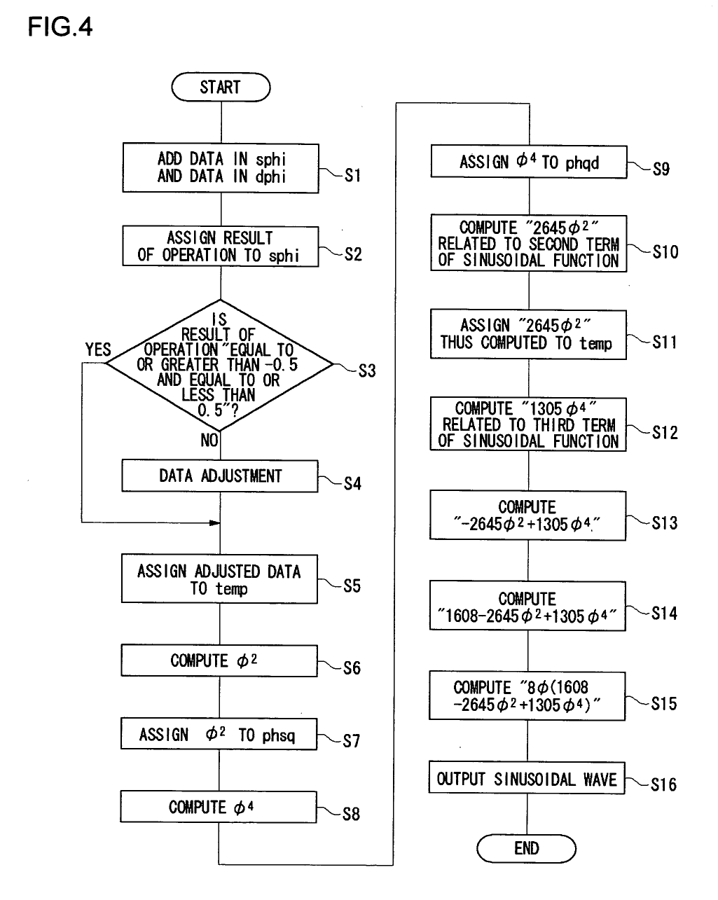

The sinusoidal wave computing unit 32 obtains data related to the sinusoidal wave by computing expression (5). More specifically, the sinusoidal wave computing unit 32 computes the sinusoidal wave in accordance with the process illustrated in FIG. 4.

FIG. 4 illustrates a process for computing the sinusoidal wave in the sinusoidal wave computing unit 32. Upon receiving an instruction from the sequence control unit 42, the register control unit 44 initializes sphi of the memory group 43. Data held in sphi is read by the register control unit 44 and assigned to the first register 46. Further, the phase component in a unit time related to a sinusoidal wave of a desired frequency held in dphi of the memory group 43 is read by the register control unit 44 and assigned to the second register 48. Under the control of the sequence control unit 42, the data held in the first register 46 and the data held in the second register 48 are sent to the ALU 50 according to a predetermined timing schedule. The sequence control unit 42 supplies an add instruction predicated to avoid overflow to the ALU 50. The ALU 50 adds the data sent from the first register 46 and the data from the second register 48, in accordance with an add instruction supplied from the sequence control unit 42 (S1 of FIG. 4). The result of addition in the ALU 50 is sent to the register control unit 44 and stored in sphi of the memory group 43 (S2).

The sequence control unit 42 determines whether the result of operation by the ALU 50 held in sphi is equal to or greater than −0.5 and equal to or less than 0.5 (S3). If the data held in sphi is equal to or greater than −0.5 and equal to or less than 0.5 (YES in S3), the register control unit 44 assigns the data held in sphi to temp of the memory group 43 in accordance with an instruction from the sequence control unit 42 (S5). Steps S4 and S5 described later are skipped so that the control is turned to step S6.

If the data held in sphi is not “equal to or greater than −0.5 and equal to or less than 0.5” (NO in S3), the sequence control unit 42 determines whether the data held in sphi is equal to or greater than 0 (S4). If the data held in sphi is equal to or greater than 0, “1” is assigned to the first register 46 via the register control unit 44 receiving an instruction from the sequence control unit 42. The data held in sphi is assigned to the second register 48. If the data held in sphi is below 0, “1” is assigned to the first register 46 via the register control unit 44 receiving an instruction from the sequence control unit 42. The data held in sphi is assigned to the second register 48. The data held in the first register 46 and the data in the second register 48 are sent to the ALU 50 according to a predetermined timing schedule. An subtract instruction predicated to avoid overflow is supplied from the sequence control unit 42 to the ALU 50. The ALU 50 subtracts the data held by the second register 48 from the data held by the first register 46. The result of subtraction in the ALU 50 is sent to the register control unit 44 and assigned to temp of the memory group 43 (S5). Though steps S1-S5 described above, the phase component φ in expression (5) is computed and stored in temp of the memory group 43.

Thus, in computing the phase component φ according to this embodiment, the value of phase of the trigonometric function is bounded by a shift operation to fall within the range from −½π to ½π, i.e. the phase component φ is made to fall within the range from −0.5 to 0.5. The computation is done on the phase component thus shifted.

The data related to the phase component φ held in temp of the memory group 43 is assigned to each of the first register 46 and the second register 48 via the register control unit 44 receiving an instruction from the sequence control unit 42. The data held in the first register 46 and the second register 48 are sent to the ALU 50 according to a predetermined timing schedule. A multiply instruction is supplied from the sequence control unit 42 to the ALU 50. The ALU 50 multiplies the data held in the first register 46 by the data held in the second register 48 (S6). The result of operation by the ALU 50 is sent to the sequence control unit 42 and assigned to phsq of the memory group 43 (S7). With this, a square component φ² in expression (5) is computed and stored in phsq of the memory group 43.

The square component φ² of the phase component φ computed by the ALU 50 and stored in phsq of the memory group 43 is assigned to each of the first register 46 and the second register 48 via the register control unit 44 receiving an instruction from the sequence control unit 42. The data held in the first register 46 and the data in the second register 48 are sent to the ALU 50 according to a predetermined timing schedule. A multiply instruction is supplied from the sequence control unit 42 to the ALU 50. The ALU 50 multiplies the data sent from the first register 46 by the data sent from the second register 48 so as to compute the quadruplicate component φ⁴ of the phase component φ (S8). The result of operation by the ALU 50 is sent to the sequence control unit 42 and the quadruplicate component φ⁴ of the phase component φ is assigned to phqd of the memory group 43 (S9).

The data related to the square component φ² of the phase component φ held in phsq of the memory group 43 is assigned to the first register 46 via the register control unit 44. Also, the data held in rom1 of the memory group 43 is assigned to the second register 48. The data held in the first register 46 and the data in the second register 48 are sent to the ALU 50 according to a predetermined timing schedule. A multiply instruction is supplied from the sequence control unit 42 to the ALU 50. The ALU 50 computes “2645φ²” by multiplying the data sent from the first register 46 by the data sent from the second register 48 (S10). The result of operation by the ALU 50 is sent to the register control unit 44 and “2645φ²” is assigned to temp of the memory group 43 (S11).

The data related to the quadruplicate component φ⁴ of the phase component φ held in phqd of the memory group 43 is assigned to the first register 46 via the register control unit 44. The data held in rom2 of the memory group 43 is assigned to the second register 48. The data held in the first register 46 and the data in the second register 48 are sent to the ALU 50 according to a predetermined timing schedule. A multiply instruction is sent from the sequence control unit 42 to the ALU 50. The ALU 50 multiplies the data sent from the first register 46 by the data sent from the second register 48 so as to compute “1305φ⁴” (S12).

The result of operation by the ALU 50 is assigned to the first register 46 and the data held in temp of the memory group 43 is assigned to the second register 48 via the register control unit 44. The data held in the first register 46 and the data in the second register 48 are sent to the ALU 50 according to a predetermined timing schedule. A subtract instruction is supplied from the sequence control unit 42 to the ALU 50. The ALU 50 determines a difference between the data sent from the first register 46 and the data sent from the second register 48 so as to compute −2645φ²+1305φ⁴” (S13).

When the result of operation by the ALU 50 is assigned to the first register 46, the data held in rom0 of the memory group 43 is assigned to the second register 48 via the register control unit 44. The data held in the first register 46 and the data in the second register 48 are sent to the ALU 50 according to a predetermined timing schedule. An add instruction is sent from the sequence control unit 42 to the ALU 50. The ALU 50 adds the data sent from the first register 46 to the data sent from the second register 48 so as to compute “1608−2645φ²+1305φ⁴” (S14).

When the result of operation by the ALU 50 is assigned to the first register 46, the data related to the phase component φ held in sphi of the memory group 43 is assigned to the second register 48. The data held in the first register 46 and the data in the second register 48 are sent to the ALU 50 according to a predetermined timing schedule. A multiply and shift-by-three instruction is supplied from the sequence control unit 42 to the ALU 50. The ALU 50 multiplies the data sent from the first register 46 by the data sent from the second register 48 and shifts the resultant data by 3 bits (S15). 3-bit shift generally obtains a value 8 times the original. Thus, the computation of expression (5) by the ALU 50 is completed in step S15 described above.

Subsequently, the sinusoidal wave computed by the ALU 50 and represented by expression (5) above is subject to output timing regulation by the output timing controller 52 and is output to the sinusoidal wave synthesizing unit 34 (S16).

As described, the sinusoidal wave computing unit 32 computes the phase component φ in steps S1-S5. In steps S6 and S7, the square component φ² of the phase component φ is computed. In steps S8 and S9, the quadruplicate component φ⁴ of the phase component φ is computed. In steps S10 and S11, the second term component “2645φ²” in expression (5) is computed. In step S12, the third term component “1305φ⁴” of expression (5) is computed. In steps S13-S15, the whole of expression (5) is computed.

The sinusoidal wave computing unit 32 according to this embodiment is capable of computing and outputting a sinusoidal wave with high precision. For example, there is a tendency for a computing error in the arithmetic operation by the sinusoidal wave computing unit 32 to be increased as the absolute value of the phase component φ is increased. The smaller the absolute value of the phase component φ, the higher the precision of the sinusoidal wave. In this embodiment, the phase component φ is controlled for computation to fall within the range “equal to or greater than −0.5 and equal to or less than 0.5” through steps S1-S5, and, particularly, through steps S3-S5. With this, the precision in computing a sinusoidal wave is improved. This embodiment also ensures that the computing error is controlled to minimum by shifting 3 bits in S15 to obtain a value multiplied by 8. With this, the precision in computing sinusoidal waves is improved.

Since the distortion of the Taylor expansion of the sinusoidal function approximately exhibits 55 dB, coefficients are adjusted to ensure that the distortion is equal to 55 dB or above. For this, a coefficient word length of 10 bits or greater is required. The frequency precision Ft, the sampling frequency Fs and the data word length n are related to each other as given by expression (6) below.

$$Ft = \frac{Fs}{{2}^{( n - 1 )}} \qquad ( 6 )$$

In the DTMF signal generating circuit 12 according to this embodiment or in similar circuits, it is generally considered desirable that the frequency precision Ft is 1.5% or below of the minimum frequency of the DTMF signal. Thus, the frequency precision Ft and the data word length n are determined so that the frequency precision Ft is 1% or below of the minimum frequency of the DTMF signal, allowing for a margin. Accordingly, referring to expression (6) above, when the sampling frequency Fs is 16 kHz, it is desirable that the frequency precision Ft be 3.90625 Hz and the data word length be 13 bits, considering that the minimum frequency of the low-frequency group that could be used for the DTMF signal is 697 Hz according to this embodiment. As obvious from expression (4) above, raising to the nth power is required for computation of the sinusoidal function in the sinusoidal wave computing unit 32. The multiplier of the sinusoidal wave computing unit 32 needs to be provided with the structure capable of the computation scale equal to or larger than the scale required to raise the data word length to the second power (n×n). For this reason, the multiplier of the sinusoidal wave computing unit 32 according to this embodiment is provided with the structure capable of processing multiplication of 13 bits×13 bits.

As described above, according to this embodiment, the sinusoidal wave used for the DTMF signal is obtained by arithmetic operation of terms of the Taylor expansion of the sinusoidal function. This eliminates the need for storage for storing a data table related to sinusoidal waves and reduces the circuit scale. Further, as compared to the related art where necessary data is acquired from a relatively large data related to sinusoidal waves every time a need arises, the embodiment described above achieves suppression of power consumption.

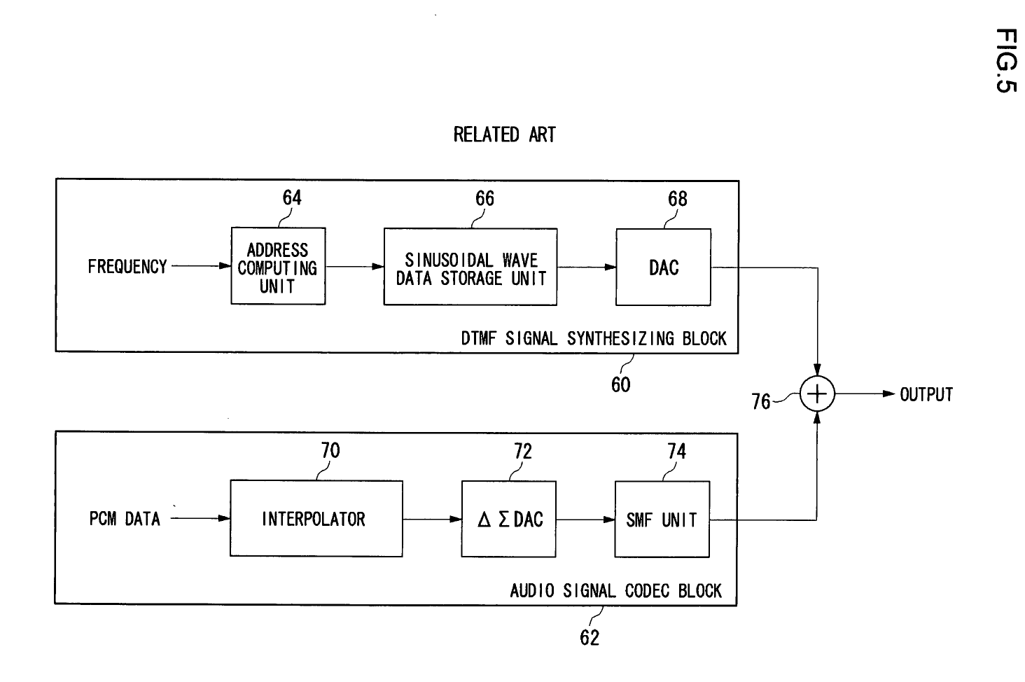

Since the DTMF signal and the audio signal are mixed in a digital stage, only one DAC needs to be provided. Accordingly, as compared with the related-art sound signal generating circuit illustrated in FIG. 5, the number of DACs is reduced and the area of analog part is reduced. Particularly, when the ΔΣ DAC 20 is shared to obtain the analog DTMF signal and audio signal, the circuit scale is effectively reduced by using a method such as resource sharing and by allowing for tradeoff between the scale and factors including the number of processing steps and power consumption.

In a fine-scale process of 1 μm pitch or below, the difference between the simple related-art circuit as illustrated in FIG. 5 and the novel circuit according to the invention is rather small as far as the digital part is concerned. In contrast, differences in circuit area and currents are predominantly large in the analog part. As such, the inventive novel circuit with the analog part constructed in a comparatively simple manner achieves reduction in currents effectively.

In the related circuit illustrated in FIG. 5, as much data as possible related to sinusoidal waves needs to be stored in a storage such as ROM in order to improve precision of sinusoidal waves generated. Therefore, it has been difficult to achieve improvement in precision of sinusoidal waves and reduction in circuit scale in a compatible manner. In contrast, this embodiment enables obtaining a sinusoidal wave of desired precision, by appropriately selecting the number of terms of the Taylor expansion of the sinusoidal function to be computed. With this, circuit scale is prevented from being increased excessively while securing the precision required of the sinusoidal wave.

The present invention is not limited to the embodiment described above. Combinations of elements of the above embodiment and those of variations not specifically described herein, are also within the scope of the embodiment. It will be apparent that variations in design and the like may be made to the embodiment and the variations within the scope of the invention.

For example, while the audio signal is described as being mixed with the DTMF signal in the above embodiment, the present invention is also applicable to cases where the DTMF signal is mixed with other signals.

While the description above concerns an example of computing a sinusoidal wave used for the DTMF signal. The present invention is also applicable to cases where sinusoidal waves used for other signals are computed.

The circuit architecture of the sinusoidal wave computing unit illustrated in FIG. 3 is only by way of illustrating a structure for implementing the present invention. Other structure may also be used to implement the present invention. While a sinusoidal wave is described as being computed by the process illustrated in FIG. 4, the present invention is also applicable to cases where sinusoidal wave is computed by other processes.

While the description above concerns an example of computing a sinusoidal wave in the sinusoidal wave computing unit 32, the present invention is also applicable to cases where terms of the Taylor expansion of a trigonometric function other than a sinusoidal function are arithmetically computed so as to compute a trigonometric wave other than a sinusoidal wave. It is also possible to use a series expansion other than Taylor expansion.

1. A trigonometric wave generating circuit comprising an operator which determines terms of a series expansion of a trigonometric function by direct arithmetic operation, so as to generate a trigonometric wave.

2. The trigonometric wave generating circuit according to claim 1, further comprising a memory which holds coefficients of the terms of the series expansion of the trigonometric function.

3. The trigonometric wave generating circuit according to claim 1, wherein the operator performs the operation after bounding the phase of the trigonometric function to fall within a range from −½π to ½π by a shift operation.

4. The trigonometric wave generating circuit according to claim 2, wherein the operator performs the operation after bounding the phase of the trigonometric function to fall within a range from −½π to ½π by a shift operation.

5. A dual tone multi-frequency signal generating circuit comprising:
a first frequency sinusoidal wave generating unit which computes a sinusoidal wave of a first frequency using a series expansion;
a second frequency sinusoidal wave generating unit which computes a sinusoidal wave of a second frequency using a series expansion; and
a sinusoidal wave synthesizing unit which synthesizes the sinusoidal wave computed by the first frequency sinusoidal wave generating unit and the sinusoidal wave computed by the second frequency sinusoidal wave generating unit.

6. The dual tone multi-frequency signal generating circuit according to claim 5, wherein the first frequency sinusoidal wave generating unit and the second frequency sinusoidal wave generating unit are formed to share a single trigonometric wave generating circuit according to claim 1.

7. The dual tone multi-frequency signal generating circuit according to claim 6, further comprising a frequency designating unit which designates the first frequency and the second frequency to the single trigonometric wave generating circuit.

8. A sound signal generating circuit comprising:
the dual tone multi-frequency signal generating circuit according to claim 5;
an acoustic signal generating unit which generates a digital acoustic signal; and
a mixing unit which mixes the digital dual tone multi-frequency signal generated by the dual tone multi-frequency signal generating unit with the digital acoustic signal generated by the acoustic signal generating unit.

9. A sound signal generating circuit comprising:
the dual tone multi-frequency signal generating circuit according to claim 6;
an acoustic signal generating unit which generates a digital acoustic signal; and
a mixing unit which mixes the digital dual tone multi-frequency signal generated by the dual tone multi-frequency signal generating unit with the digital acoustic signal generated by the acoustic signal generating unit.

10. A sound signal generating circuit comprising:
the dual tone multi-frequency signal generating circuit according to claim 7;
an acoustic signal generating unit which generates a digital acoustic signal; and
a mixing unit which mixes the digital dual tone multi-frequency signal generated by the dual tone multi-frequency signal generating unit with the digital acoustic signal generated by the acoustic signal generating unit.

11. The sound signal generating circuit according to claim 8, further comprising:
an interpolator which interpolates between values of the sound signal mixed by the mixing unit;
a ΔΣ D/A converter which subjects an output signal from the interpolator to digital-to-analog conversion; and
a filter provided in a stage subsequent to the ΔΣ D/A converter.

12. The sound signal generating circuit according to claim 9, further comprising:
an interpolator which interpolates between values of the sound signal mixed by the mixing unit;
a ΔΣ D/A converter which subjects an output signal from the interpolator to digital-to-analog conversion; and
a filter provided in a stage subsequent to the ΔΣ D/A converter.

13. The sound signal generating circuit according to claim 10, further comprising:
an interpolator which interpolates between values of the sound signal mixed by the mixing unit;
a ΔΣ D/A converter which subjects an output signal from the interpolator to digital-to-analog conversion; and
a filter provided in a stage subsequent to the ΔΣ D/A converter.

14. A communication apparatus comprising the audio signal generating circuit according to claim 8.

15. A communication apparatus comprising the audio signal generating circuit according to claim 11.
